(19) United States
(12) Patent Application Publication
(10) Pub. No.: US 2026/0338321 A1
(43) Pub. Date: Oct. 29, 2026

(54) LAPTOP BRACKET

(71) Applicant: Christopher P. Fleming, Grosse Ile, MI (US)

(72) Inventor: Christopher P. Fleming, Grosse Ile, MI (US)

(21) Appl. No.: 19/116,103

(22) PCT Filed: Sep. 29, 2022
(86) PCT No.: PCT/US2022/045167

§ 371 Date: Mar. 27, 2025

(51) Int. Cl. F16M 13/02; G06F 1/16

(52) U.S. Cl. CPC F16M 13/02; G06F 1/1681

(57) ABSTRACT

A laptop bracket includes a first support, a second support, multiple hinge devices, multiple arms, and multiple clamps. The first support is configured to receive a keyboard portion of a laptop. The second support is configured to receive a screen portion of the laptop. The hinge devices are configured to rotatably couple the first support to the second support, and accommodate a variable separation between the first support and the second support in response to a rotation of a laptop hinge. Each arm has an outer end moveable proximate an outer perimeter of the laptop. The clamps are attached to the outer ends of the arms, and are configured to grip the keyboard portion and the screen portion of the laptop proximate the outer perimeter of the laptop.

The present disclosure relates to an apparatus and a method for supporting a laptop.

Existing laptop brackets provide loose supports that hold a laptop computer in place while the laptop is in a normal keyboard-horizontal, screen vertical orientation. However, if the orientation is changed, the laptop brackets generally do not provide sufficient hold on the laptop to prevent the laptop from shifting within, or even falling out of the laptop brackets.

Accordingly, those skilled in the art continue with research and development efforts in the field of supporting a laptop in non-normal orientations.

### SUMMARY

A laptop bracket is provided herein. The laptop bracket is configured to hold a laptop having an outer perimeter and a screen portion coupled to a keyboard portion through a laptop hinge. The laptop bracket includes a first support, a second support, a plurality of hinge devices, a plurality of arms, and a plurality of clamps. The first support defines a first planar surface, a first side, a second side, a third side opposite the second side, and a fourth side opposite the first side. The first support is configured to receive the keyboard portion of the laptop against the first planar surface. The second support defines a second planar surface, a fifth side, a sixth side, a seventh side opposite the sixth side, and an eighth side opposite the fifth side. The second support is configured to receive the screen portion of the laptop against the second planar surface. The plurality of hinge devices is coupled between the fourth side of the first support and the eighth side of the second support. The plurality of hinge devices are configured to rotatably couple the first support to the second support, and accommodate a variable separation between the fourth side of the first support and the eighth side of the second support in response to a rotation of the laptop hinge. The plurality of arms each have an outer end moveable proximate the outer perimeter of the laptop. Each of the plurality of arms has an inner end opposite the outer end and separated from the outer end by an adjustable length. The inner ends are attached to the first side, the second side, and the third side of the first support, and the fifth side, the sixth side, and the seventh side of the second support. The plurality of clamps are attached to the outer ends of the plurality of arms. The plurality of clamps are configured to grip the keyboard portion and the screen portion of the laptop proximate the outer perimeter of the laptop.

In one or more embodiments of the laptop bracket, the adjustable length of each of the plurality of arms is held constant while the second support is rotated relative to the first support.

In one or more embodiments, the laptop bracket further includes a plurality of locking devices connected to plurality of arms. Each of the plurality of locking devices is configured to hold constant the adjustable length of one of the plurality of arms in a first mode, and enable the adjustable length to change in a second mode.

In one or more embodiments of the laptop bracket, a plurality of positions of the plurality of clamps on the laptop is held stationary while the second support is moved relative to the first support.

In one or more embodiments of the laptop bracket, the plurality of arms and the plurality of clamps along the first side of the first support are configured to hold the laptop stationary while the keyboard portion of the laptop applies a force of up to 70 newtons of force in a direction parallel to the first planar surface and from the fourth side toward the first side.

In one or more embodiments, the laptop bracket further includes a mechanical stop attached to the first support proximate the first side and protruding normal to the first planar surface. The mechanical stop is configured to prevent the keyboard portion of the laptop from moving a direction from the fourth side toward the first side.

In one or more embodiments of the laptop bracket, the plurality of hinge devices includes a plurality of double-action hinges.

In one or more embodiments, the laptop bracket further includes at least one mounting stud connected to the first support.

In one or more embodiments, the laptop bracket further includes at least one mounting stud connected to the second support.

In one or more embodiments of the laptop bracket, at least one of the plurality of clamps includes: a flexible bar having an open end and a connector end opposite the open end, wherein the connector end is coupled to the outer end of one of the plurality of arms; and a resilient pad disposed at the open end, wherein the resilient pad is configured to bias the laptop against the one of the plurality of arms.

In one or more embodiments of the laptop bracket, at least one of the plurality of clamps includes: a resilient pad configured to engage the laptop; a bar coupled between the resilient pad and the outer end of one of the plurality of arms; and a joint disposed between the bar and the outer end of the one of the plurality of arms, wherein the joint is spring-loaded to force the resilient pad against the laptop to force the laptop against the one of the plurality of arms.

In one or more embodiments of the laptop bracket, at least one of the plurality of clamps includes: a plate configured to engage the laptop; and a thumb screw disposed between the plate and the outer end of one of the plurality of arms, wherein the thumb screw forces the plate against the laptop to force the laptop against the one of the plurality of arms.

In one or more embodiments of the laptop bracket, at least one of the plurality of clamps includes: a spring-loaded joint coupled to the outer end of one of the plurality of arms; and a plurality of squeeze pads coupled to the spring-loaded joint, wherein the plurality of squeeze pads is configured to bias the laptop against the one of the plurality of arms.

In one or more embodiments of the laptop bracket, at least one of the plurality of clamps includes: a clip rotatably coupled to the outer end of one of the plurality of arms, wherein the clip is configured to engage the laptop; and a plurality of magnets disposed between the clip and the outer end of the one of the plurality of arms, wherein the plurality of magnets force the clip against the laptop to force the laptop against the plurality of arms.

In one or more embodiments of the laptop bracket, at least one of the plurality of clamps includes an adjustable strap connected to one of the outer ends of the plurality of arms, wherein the adjustable strap is configured to bias the laptop against the one of the plurality of arms.

In one or more embodiments of the laptop bracket, at least of the plurality of hinge devices includes a double-action hinge connected between the first support and the second support.

In one or more embodiments of the laptop bracket, at least of the plurality of hinge devices includes a strap connected between the first support and the second support, wherein the strap includes a plurality of serrated teeth that enables the strap to adjust in length as the laptop is opened and closed.

In one or more embodiments of the laptop bracket, at least one of the plurality of hinge devices includes: a lower bridge coupled to the first support; and an upper bridge coupled to the second support, wherein a plurality of pop studs and a plurality of holes releasably couple the lower bridge to the upper bridge at a plurality of positions.

In one or more embodiments, the laptop bracket includes a first mounting stud coupled to the first support and a second mounting stud coupled to the second support. The first mounting stud is configured to hold the first planar surface of the first support at an angle of approximately 30 degrees to approximately 60 degrees relative to the second planar surface of the second support.

A method for supporting a laptop is provided herein. The laptop has an outer perimeter and a screen portion coupled to a keyboard portion through a laptop hinge. The method includes receiving the keyboard portion of the laptop against a first planar surface of a first support. The first support defines the first planar surface, a first side, a second side, a third side opposite the second side, and a fourth side opposite the first side. The method includes receiving the screen portion of the laptop against a second planar surface of a second support. The second support defines the second planar surface, a fifth side, a sixth side, a seventh side opposite the sixth side, and an eighth side opposite the fifth side. The method further includes rotatably coupling the first support to the second support with a plurality of hinge devices coupled between the fourth side of the first support and the eighth side of the second support. The plurality of hinge devices are configured to accommodate a variable separation between the fourth side of the first support and the eighth side of the second support in response to a rotation of the laptop hinge. The method includes moving an outer end of each of a plurality of arms proximate to the outer perimeter of the laptop. Each of the plurality of arms has an inner end opposite the outer end and separated from the outer end by an adjustable length. The inner ends are attached to the first side, the second side, and the third side of the first support, and the fifth side, the sixth side, and the seventh side of the second support. The method further includes gripping the keyboard portion and the screen portion of the laptop proximate to the outer perimeter of the laptop with a plurality of clamps, wherein the plurality of clamps are attached to the outer ends of the plurality of arms.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic plan diagram of a laptop bracket in an open configuration in accordance with one or more exemplary embodiments.

FIG. 2 is a side schematic view of the laptop mounted within the laptop bracket in accordance with one or more exemplary embodiments.

FIG. 3 is a schematic side view diagram of the laptop and the laptop bracket hanging in a vertical direction in accordance with one or more exemplary embodiments.

FIG. 4 is a schematic side view diagram of a first clamp in accordance with one or more exemplary embodiments.

FIG. 5 is a schematic side view diagram of a second clamp in accordance with one or more exemplary embodiments.

FIG. 6 is a schematic side view diagram of a third clamp in accordance with one or more exemplary embodiments.

FIG. 7 is a schematic perspective view diagram of a fourth clamp in accordance with one or more exemplary embodiments.

FIG. 8 is a schematic side view diagram of a fifth clamp in accordance with one or more exemplary embodiments.

FIG. 9 is a schematic plan view diagram of a sixth clamp in accordance with one or more exemplary embodiments.

FIG. 10 is a schematic side view diagram of a first hinge device in accordance with one or more exemplary embodiments.

FIG. 11 is a schematic diagram of a second hinge device in accordance with one or more exemplary embodiments.

FIG. 12 is a schematic side view of a third hinge device in accordance with one or more exemplary embodiments.

FIG. 13 is a flow diagram of a method to support the laptop in accordance with one or more exemplary embodiments.

FIG. 14 is a schematic diagram of a first mounting stud in accordance with one or more exemplary embodiments.

FIG. 15 is a schematic diagram of a second mounting stud in accordance with one or more exemplary embodiments.

FIG. 16 is a schematic side view diagram of two modes of an arm in accordance with one or more exemplary embodiments.

FIG. 17 is a schematic plan view diagram of a first arm with a first locking device in accordance with one or more exemplary embodiments.

FIG. 18 is a schematic plan view diagram of a second arm with a second locking device in accordance with one or more exemplary embodiments.

FIG. 19 is a schematic side view diagram of a third arm with a third locking device in accordance with one or more exemplary embodiments.

FIG. 20 is a schematic plan view diagram of a fourth arm with a fourth locking device in accordance with one or more exemplary embodiments.

FIG. 21 is a schematic plan view diagram of a fifth arm with a fifth locking device in accordance with one or more exemplary embodiments.

FIG. 22 is a schematic plan view diagram of a sixth arm and a sixth locking device in accordance with one or more exemplary embodiments.

FIG. 23 is a schematic perspective view diagram of a seventh arm and a seventh locking device in accordance with one or more exemplary embodiments.

FIG. 24 is a schematic perspective view diagram of a first mechanical stop in accordance with one or more exemplary embodiments.

FIG. 25 is a schematic plan view diagram of a second mechanical stop in accordance with one or more exemplary embodiments.

FIG. 26 is a schematic perspective view diagram of a third mechanical stop in accordance with one or more exemplary embodiments.

FIG. 27 is a schematic bottom view diagram of a second laptop bracket in accordance with one or more exemplary embodiments.

FIG. 28 is a schematic bottom view diagram of a third laptop bracket in accordance with one or more exemplary embodiments.

### DETAILED DESCRIPTION

Embodiments of the disclosure generally provide a laptop bracket having retractable arms that adjust to different sizes of a variety of laptops. A clamp is provided at the end of each adjustable arm to grip the laptop and hold the laptop to the laptop bracket at non-horizontal keyboard orientations. Once the laptop is installed, the laptop bracket may be oriented such that the laptop keyboard is right side up, the laptop keyboard is right side down, the laptop keyboard is vertical, and other orientations, while still holding the laptop regardless of a direction of gravity and/or other external forces acting upon the laptop. As used herein, right side up generally means to be oriented in such a way that the upper and lower parts are in usual positions and not reversed. For example, the keyboard of the laptop may be horizontal and facing essentially upward while right side up, and horizontal and facing essentially downward while right side down.

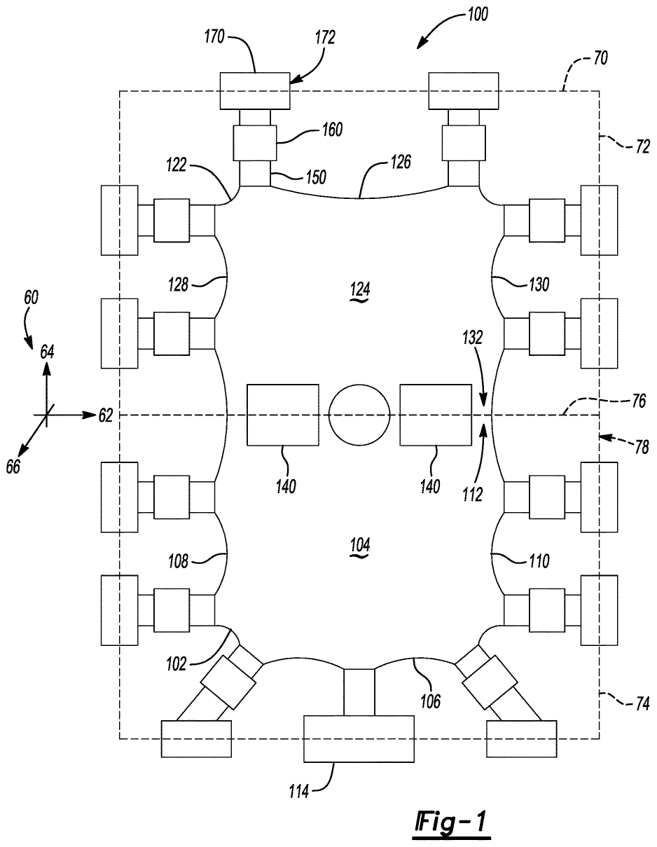

Referring to FIG. 1, a schematic plan diagram of an example implementation of a laptop bracket 100 in an open configuration is shown in accordance with one or more exemplary embodiments. The laptop bracket 100 is described in terms of an orthogonal coordinate system 60. The orthogonal coordinate system 60 may include an X axis 62, a Y axis 64 and a Z axis 66. The laptop bracket 100 is configured to cradle a laptop 70.

The laptop 70 implements a portable computing device. The laptop 70 generally has a screen portion 72 rotatably coupled to a keyboard portion 74 by a laptop hinge 76. The screen portion 72 and the keyboard portion 74 define an outer perimeter 78 of the laptop 70. In various embodiments, the laptop 70 may range in size from an 11 inch laptop to a 17 inch laptop.

The laptop bracket 100 implements a laptop mounting device. The laptop bracket 100 is operational to hold the laptop 70 secure while the laptop 70/laptop bracket 100 are at any orientation within the orthogonal coordinate system 60. The laptop bracket 100 includes a first support 102, a second support 122, a mechanical stop 114, multiple hinge devices 140, multiple arms 150, multiple locking devices 160, and multiple clamps 170.

The first support 102 is configured to engage the keyboard portion 74 of the laptop 70. The first support 102 defines a first planar surface 104, a first side 106 (e.g., the bottom side as illustrated), a second side 108 (e.g., the left side as illustrated), a third side 110 (e.g., the right side as illustrated), and a fourth side 112 (e.g., a top side as illustrated). The mechanical stop 114 may be attached to the first support 102 along the first side 106. The mechanical stop 114 is configured to stop movement of the laptop 70 in a direction from the fourth side 112 toward the first side 106. In one or more orientations, the movement of the laptop 70 from the fourth side 112 toward the first side 106 may be due to a gravitational pull on the laptop 70.

The second support 122 is configured to engage the screen portion 72 of the laptop 70. The second support 122 defines a second planar surface 124, a fifth side 126 (e.g., the top side as illustrated), a sixth side 128 (e.g., the left side as illustrated), a seventh side 130 (e.g., the right side as illustrated), and an eighth side 132 (e.g., the bottom side as illustrated). The eighth side 132 of the second support 122 faces and is parallel to the first side 106 of the first support 102.

The hinge devices 140 rotatably and translationally couple the first support 102 to the second support 122. The hinge device 140 provide for multiple degrees of freedom that allow the second support 122 to rotate and move relative to the first support 102 as the screen portion 72 of the laptop 70 is opened and closed relative to the keyboard portion 74. In one or more embodiments, the hinge devices 140 may be implemented as double-action hinges, adjustable straps, simple hinges, and the like. Other arrangements may be implemented to meet the design criteria of a particular application.

The arms 150 implement variable length arms. Multiple (e.g., four to eight) arms 150 may be connected directly to the first support 102 and support the keyboard portion 74 of the laptop 70. Multiple (e.g., four to eight) arms 150 may be connected directly to the second support 122 and support the screen portion 72 of the laptop 70. Each arm 150 has an inner end that connects to the first support 102 or the second support 122. Each arm 150 has an outer end that is moveable to align with the outer perimeter 78 of the laptop at respective locations 172 along the laptop 70.

The locking devices 160 are disposed along each arm 150. The locking device 160 are operational in a first mode to enable (or allow) lengths of the corresponding arms 150 to change. In a second mode, the locking devices 160 are operational to fix the length of the corresponding arms 150.

The clamps 170 are disposed at the outer ends of the arms 150. The clamps 170 are operational to alternatively grip and release the laptop 70. While gripping the laptop 70, the clamps 170 hold the laptop 70 stationary relative to the arms 150 at the locations 172. While the clamps 170 release the laptop 70, the length of the arms 150 may be adjusted to match a size of the screen portion 72 and the keyboard portion 74.

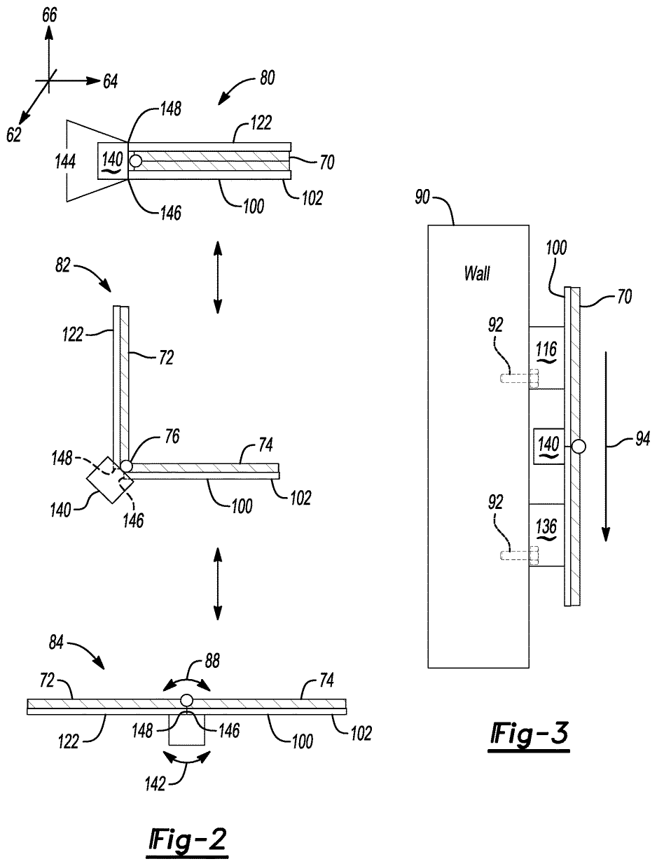

Referring to FIG. 2, a side schematic view of the laptop 70 mounted within the laptop bracket 100 is shown in accordance with one or more exemplary embodiments. A top illustration shows the laptop 70/laptop bracket 100 in a laptop closed configuration 80. A middle illustration shows the laptop 70/laptop bracket 100 in a laptop partially opened configuration 82. A bottom illustration shows the laptop 70/laptop bracket 100 in a laptop fully opened configuration 84. A rotation of the laptop hinge 76 between the laptop closed configuration 80 and the laptop fully opened configuration 84 is designated as a rotation 88. A rotation of the hinge device 140 is designated as a rotation 142.

While in the laptop closed configuration 80, the hinge device 140 of the laptop bracket 100 is shown with a variable separation 144 between a first point 146 on the first support 102 and a second point 148 on the second support 122. While in the laptop partially opened configuration 82, the hinge device 140 allows the first point 146 and the second point 148 to move closer to each other. While in the laptop fully opened configuration 84, the hinge device 140 allows the first point 146 and the second point 148 to be in close proximity to or touching each other.

Referring to FIG. 3, a schematic side view diagram of the laptop 70 and the laptop bracket 100 hanging in a vertical direction is shown in accordance with one or more exemplary embodiments. The laptop bracket 100 may include one or more second mounting studs 116 and/or one or more first mounting studs 136. The second mounting studs 116 may be coupled to the second support 122. The first mounting studs 136 may be coupled to the first support 102.

The second mounting studs 116 and/or the first mounting studs 136 are configured to engage a vertically orientated structure (e.g., a wall) 90 with one or more bolts (or fasteners) 92. In various embodiments, the engagement may be a direct engagement of the wall 90. In other embodiments, the engagement may be an indirect engagement of the wall 90 with brackets, cables and/or other mechanisms that hold the laptop bracket 100 to the wall 90.

The laptop 70 and the laptop bracket 100 are illustrated in the laptop fully opened configuration 84. The second mounting studs 116 and/or the first mounting studs 136 are designed to provide clearance between the wall 90 and the first support 102 and the second support 122 to accommodate the hinge device 140.

A force downward (e.g., a gravitational force) 94 may act on the laptop 70 and the laptop bracket 100. The second mounting studs 116 and/or the first mounting studs 136 are secured to the wall 90 to prevent the laptop bracket 100 from moving downward. The laptop 70 is secured in the laptop bracket 100 (e.g., held by the mechanical stop 114 and possibly the clamp 170—see FIG. 1) to keep the laptop 70 from moving downward due to the gravitational force 94. In various embodiments, the laptop 70 may apply in a range of 20 Newtons to 70 Newtons of force downward on the laptop bracket 100.

In various embodiments, the first support 102 and/or the second support 122 may include multiple grommets and/or eyelets around a periphery of the laptop bracket 100. The grommets/eyelets may be paired with ropes, bungee cords and/or hooks to hang the laptop bracket 100 and the laptop 70 from the vertically orientated structure.

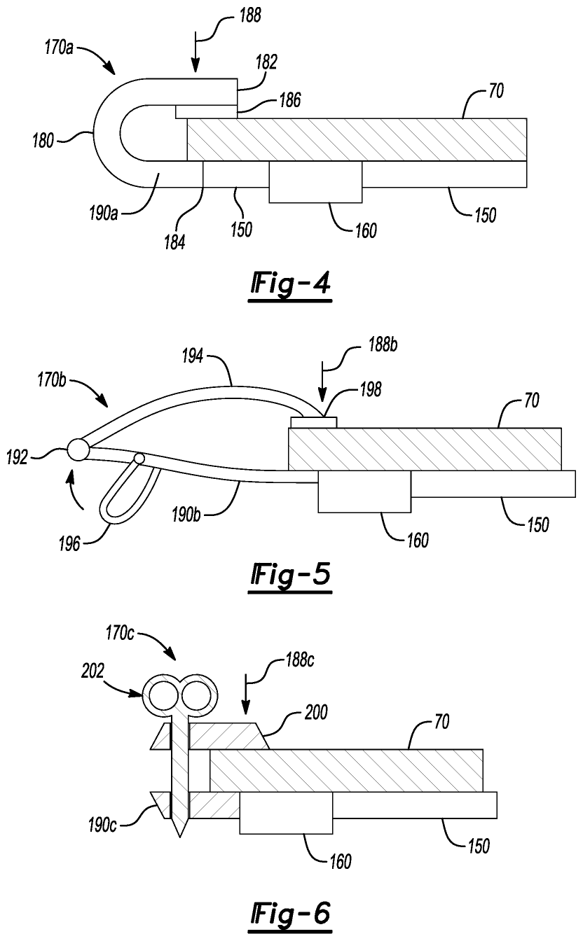

Referring to FIG. 4, a schematic side view diagram an example implementation of a first clamp 170a is shown in accordance with one or more exemplary embodiments. The first clamp 170a is representative of the clamps 170 shown in FIG. 1.

The first clamp 170a includes a flexible bar 180, a resilient pad 186, and a first segment 190a. The flexible bar 180 may have an open end 182 and a connector end 184 opposite the open end 182. The first segment 190a is located between the flexible bar 180 and the connector end 184. The resilient pad 186 is connected to the flexible bar 180 proximate the open end 182. The connector end 184 is connected to the arm 150 beyond the locking devices 160.

While the laptop 70 (e.g., the screen portion 72 or the keyboard portion 74) is inserted between the resilient pad 186, the first segment 190a, the flexible bar 180 may bend to accommodate a thickness of the laptop 70. The resilient pad 186 applies a first bias (or first force) 188 that presses the laptop 70 against the first segment 190a and/or the arm 150.

Referring to FIG. 5, a schematic side view diagram of an example implementation of a second clamp 170b is shown in accordance with one or more exemplary embodiments. The second clamp 170b is representative of the clamps 170 shown in FIG. 1.

The second clamp 170b includes a second segment 190b, a spring-loaded joint 192, a bar 194, a fastener 196 and a squeeze pad 198. The second segment 190b is connected to the arm 150. The bar 194 is coupled to the second segment 190b through the spring-loaded joint 192. The squeeze pad 198 is connected to an open end of the bar 194 opposite the spring-loaded joint 192. The fastener 196 is rotatably connected to the second segment 190b. The fastener 196 is operational to rotate over and engage the bar 194. The engagement of the fastener 196 with the bar 194 causes the squeeze pad 198 to apply a second bias 188b (or second force) that squeezes the laptop 70 between the second segment 190b and the squeeze pad 198.

Referring to FIG. 6, a schematic side view diagram of an example implementation of a third clamp 170c is shown in accordance with one or more exemplary embodiments. The third clamp 170c is representative of the clamps 170 shown in FIG. 1.

The third clamp 170c includes a third segment 190c, a plate 200, and a thumb screw 202. The third segment 190c is connected to the arm 150. The plate 200 is coupled to the third segment 190c through the thumb screw 202. The thumb screw 202 may be tightened to cause the plate 200 to apply a third bias 188c (or third force) that squeezes the laptop 70 between the plate 200 and the third segment 190c. The thumb screw 202 may be loosened to allow the laptop 70 to disengage the plate 200 and/or the third segment 190c during insertion and removal.

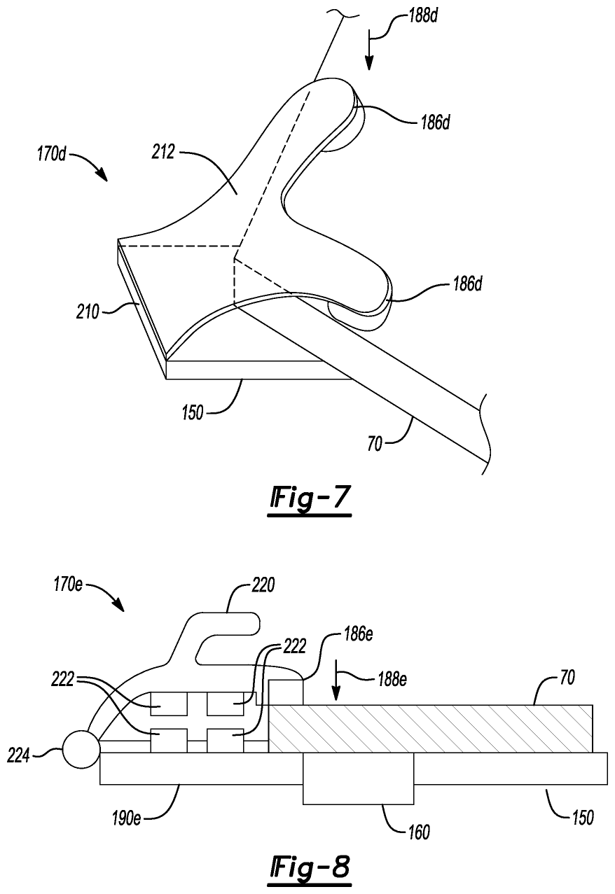

Referring to FIG. 7, a schematic perspective view diagram an example implementation of a fourth clamp 170d is shown in accordance with one or more exemplary embodiments. The fourth clamp 170d is representative of the clamps 170 shown in FIG. 1 at the corners of the laptop 70. Other clamps 170 away from the corners may be implemented by the other designs disclosed herein.

The fourth clamp 170d includes a joint 210, a bar 212, and multiple fourth resilient pad 186d. The joint 210 rotatably connects the bar 212 to the arm 150. The fourth resilient pads 186d are connected to the bar 212 opposite the joint 210. The joint 210 may be spring-loaded to cause the fourth resilient pads 186d to apply a fourth bias 188d that presses the laptop 70 against the arm 150. The bar 212 may be manually pulled away from the laptop 70 to release the fourth bias 188d.

Referring to FIG. 8, a schematic side view diagram of an example implementation of a fifth clamp 170e is shown in accordance with one or more exemplary embodiments. The fifth clamp 170e is representative of the clamps 170 shown in FIG. 1.

The fifth clamp 170e includes a fifth segment 190e, a clip 220, multiple magnets 222, a fifth hinge 224, and a fifth resilient pad 186e. The fifth segment 190e is rotatably coupled to the clip 220 thru the fifth hinge 224. The fifth resilient pad 186e is disposed on the clip 220 opposite the fifth hinge 224. The magnets 222 are disposed in pairs on the fifth segment 190e and the clip 220. Each pair of magnets 222 are orientated with opposing N poles and S poles facing each other to attract the clip 220 toward the fifth segment 190e. The attraction causes the fifth resilient pad 186e to apply a fifth bias 188e that forces the laptop 70 against the fifth segment and/or the arm 150. The clip 220 may include a tab to allow the fifth bias 188e to be removed during insertion and removal of the laptop 70.

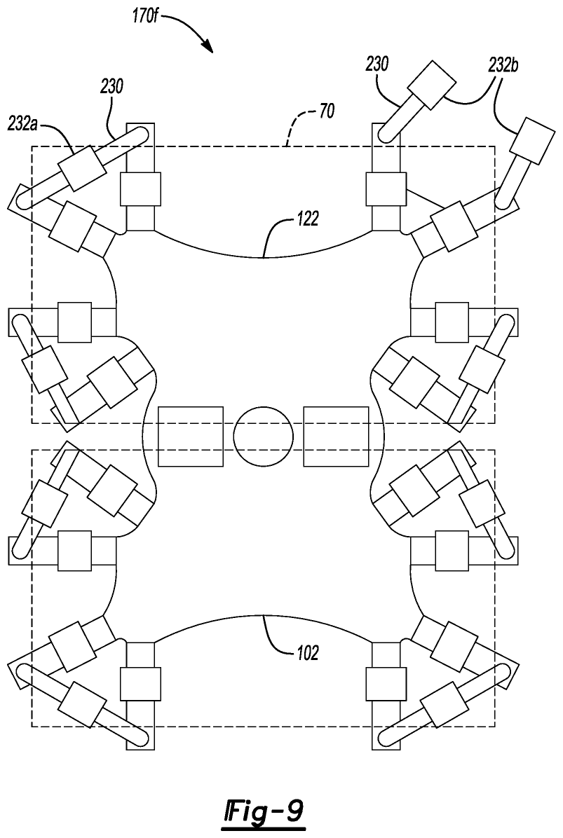

Referring to FIG. 9, a schematic plan view diagram of an example implementation of a sixth clamp 170f is shown in accordance with one or more exemplary embodiments. The sixth clamp 170f may be disposed at the corners of the laptop 70. Other clamps 170 away from the corners may be implemented by the other designs disclosed herein.

The sixth clamps 170f include adjustable straps 230 and clamp buckles. The straps 230 may span between neighboring arms 150 and cross over the corners of the laptop 70. In the illustration, several of the clamp buckles are illustrated as closed clamp buckles 232a. One of the clamp buckles is illustrated as an open clamp buckle 232b. The clamp buckles may be opened to allow for insertion and removal of the laptop 70 from the laptop bracket 100. The clamp buckles may be closed to hold the laptop 70 within the laptop bracket 100.

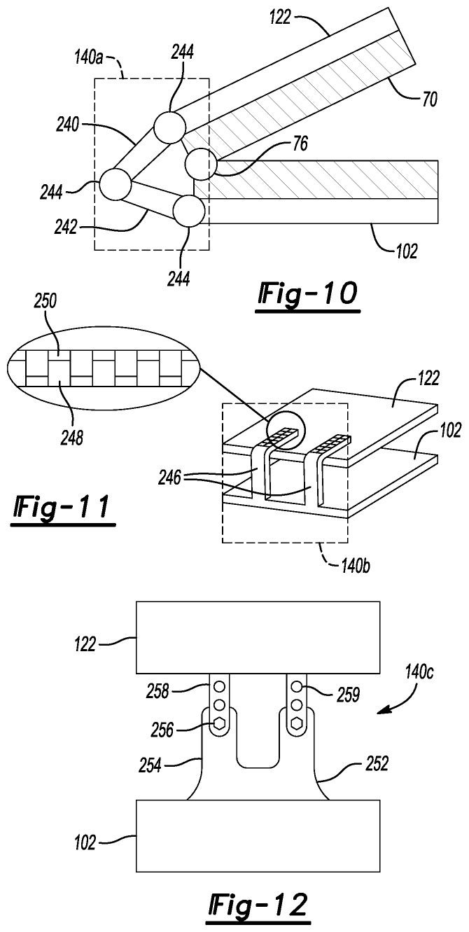

Referring to FIG. 10, a schematic side view diagram of an example implementation of a first hinge device 140a is shown in accordance with one or more exemplary embodiments. The first hinge device 140a is representative of the hinge devices 140 shown in FIG. 1. The first hinge device 140a is connected between the first support 102 and the second support 122.

The first hinge device 140a implements a double-action hinge. The first hinge device 140a includes a first arm 240, a second arm 242, and three joints 244. One joint 244 is connected to the first support 102. Another joint 244 is connected to the second support 122. A middle joint 244 is connected between the other two joints 244 by the first arm 240 and the second arm 242.

While the laptop 70 is in the laptop closed configuration, the middle joint 244 is near or touching the laptop hinge 76. While the laptop 70 is in the laptop fully opened configuration, the outer two joints 244 may be near or touching the laptop hinge 76. The middle joint 244 is subsequently pushed away from the laptop hinge 76.

Referring to FIG. 11, a schematic diagram of an example implementation of a second hinge device 140b is shown in accordance with one or more exemplary embodiments. The second hinge device 140b is representative of the hinge devices 140 shown in FIG. 1. The second hinge device 140b is connected between the first support 102 and the second support 122.

The second hinge device 140b includes multiple straps 246 coupled between the first support 102 and the second support 122. The straps 246 include upper serrated teeth 248 and lower serrated teeth 250. The upper serrated teeth 248 are configured to engage with and slide against the lower serrated teeth 250. The sliding allows the straps 246 to expand and contract as the laptop 70 is opened and closed.

Referring to FIG. 12, a schematic side view of an example implementation of a third hinge device 140c is shown in accordance with one or more exemplary embodiments. The third hinge device 140c is representative of the hinge devices 140 shown in FIG. 1. The third hinge device 140c is connected between the first support 102 and the second support 122.

The third hinge device 140c includes a lower hinge 252, a lower bridge 254, multiple pop studs 256, and an upper bridge 258. The lower hinge 252 is connected to the first support 102. The lower bridge 254 is connected to the lower hinge 252. The pop studs 256 are connected to the lower bridge 254 opposite the lower hinge 252. The upper bridge 258 is connected to the second support 122. The upper bridge 258 include multiple holes 259. The pop studs 256 may be aligned with and inserted into the holes 259 to link the first support 102 to the second support 122 at a given angle of the laptop hinge 76. To adjust the angle of the laptop hinge 76, the pop studs 256 are released (or removed) from the holes 259, the laptop hinge 76 is adjusted, and the pop studs 256 are inserted into different holes 259.

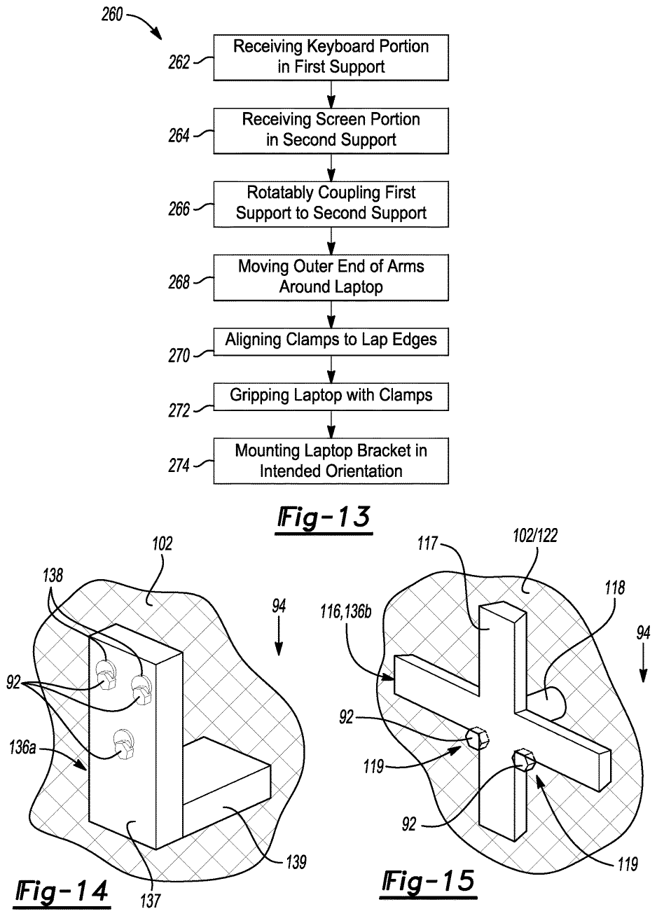

Referring to FIGS. 1 and 13, a flow diagram of an example implementation of a method 260 to support the laptop 70 is shown in accordance with one or more exemplary embodiments. The method (or process) 260 is implemented with the laptop 70 and the laptop bracket 100. The method 260 includes steps 262 to 274, as illustrated. The sequence of steps is shown as a representative example. Other step orders may be implemented to meet the criteria of a particular application.

In the step 262, the keyboard portion 74 of the laptop 70 is received against the first planar surface 104 of the first support 102. The first support 102 generally defines the first planar surface 104, the first side 106, the second side 108, the third side 110 opposite the second side 108, and the fourth side 112 opposite the first side 106. In the step 264, the screen portion 72 of the laptop 70 is received against the second planar surface 124 of the second support 122. The second support 122 defines the second planar surface 124, the fifth side 126, the sixth side 128, the seventh side 130 opposite the sixth side 128, and the eighth side 132 opposite the fifth side 126. The first support 120 and the second support 122 are rotatably coupled in the step 266 with the hinge devices 140. The hinge devices 140 are coupled between the fourth side 112 of the first support 102 and the eighth side 132 of the second support 122. The hinge devices 140 are configured to accommodate a variable separation between the fourth side 112 of the first support 102 and the eighth side 132 of the second support 122 in response to the laptop hinge 76 being rotated.

In the step 268, an outer end of each arm 150 is moved to a corresponding location proximate to the outer perimeter 78 of the laptop 70. Each arm 150 has an inner end opposite the outer end and separated from the outer end by an adjustable length. The inner ends are attached to the first side 106, the second side 108, and the third side 110 of the first support 102, and the fifth side 126, the sixth side 128, and the seventh side 130 of the second support 122. In the step 270, the clamps 170 are aligned to the edges along the outer perimeter 78 of the laptop 70. The clamps 170 subsequently grip the keyboard portion 74 and the screen portion 72 of the laptop 70 proximate to the outer perimeter 78 of the laptop 70 in the step 272. In the step 274, the laptop bracket 100 and the laptop 70 therein are mounted an intended orientation within the orthogonal coordinate system 60.

Referring to FIG. 14, a schematic diagram of an example implementation of the first mounting stud 136a is shown in accordance with one or more exemplary embodiments. The first mounting stud 136a may be a variation of the mounting stud The first mounting stud 136a is connected to the first support 102.

The first mounting stud 136a includes a block 137, one or more recesses 138 (three shown), and an optional bar 139. The block 137 is attached to the first support 102 and forms a main structure of the first mounting stud 136a. The bar 139, where implemented, is attached to the first support 102 at one end and the block 137 at the other end. A length of the bar 139 is adjusted to allow the keyboard portion 74 of the laptop 70 to stay at an angle of approximately 30 degrees to approximately 60 degrees offset from the wall 90 while the screen portion 72 is hung vertically from the wall 90 (FIG. 3). Put another way, the first planar surface 104 of the first support 102 is at approximately 30 degrees to approximately 60 degrees relative to the second planar surface 124 of the second support 122. Each recess 138 is configured to receive and secure a bolt 92 to support the laptop bracket 100 from the wall 90 to counteract the gravity 94.

While the laptop bracket 100 is hanging vertically (FIG. 3), the weight of the laptop 70 is transferred to the mechanical stop 114 and the arms 150/locking devices 160/clamps 170 along the first side 106 of the first support 102. Therefore, the mechanical stop 114 and the arms 150/locking devices 160/clamps 170 along the first side 106 are configured to support the full weight of the laptop 70. The weight of the laptop 70 and the weight of the laptop bracket 100 are subsequently transferred through the first mounting stud 136a to the wall 90 (FIG. 3) or whatever structure is supporting the laptop bracket 100.

Referring to FIG. 15, a schematic diagram of an example implementation of the second mounting stud 116 is shown in accordance with one or more exemplary embodiments. The second mounting stud 116 is connected to the second support 122. In some variations, a duplicate of the second mounting stud 116 may be used as a first mounting stud 136b connected to the first support 102. The first mounting stud 136b may be a variation of the first mounting stud 136.

Second mounting stud 116 and/or the first mounting stud 136b includes a member 117 and a support 118. The member 117 may generally have a cross-shape with one axis oriented vertically and the other axis oriented horizontally. The support 118 attaches the member 117 to the first support 102 (for first mounting studs 136b) or the second support 122 (for second mounting studs 116). While the laptop bracket 100 is hanging vertically, the bolts 92 may rest in the lower inside corners 119 of the member 117 to counteract the gravity 94 pulling the laptop bracket 100 downward.

While the laptop bracket 100 is hanging vertically (FIG. 3), the weight of the laptop 70 is transferred to the arms 150/locking devices 160/clamps 170 along the fifth side 126, the sixth side 128, and the seventh side 130 of the second support 122. Therefore, the arms 150/clamps 170 along at least the fifth side 126, the sixth side 128 and the seventh side 130 are configured to support the full weight of the laptop 70. The weight of the laptop 70 and the weight of the laptop bracket 100 are transferred through the second mounting stud 116 to the wall 90 (FIG. 3) or whatever structure is supporting the laptop bracket 100.

In various embodiments, the arms 150/locking devices 160/clamps 170 along the first side 106, the second side 108, and the third side 110 of the first support 102 may also aid in supporting the weight of the laptop 70. In designs where the weight may be conveyed through the hinge device 140, part of the weight of the laptop 70 (e.g., the weight of the keyboard portion 74) may be transferred into the first support 102, through the hinge device 140, into the second support 122, and to the second mounting stud 116.

In various embodiments, both the first mounting stud 136 and the second mounting stud 116 may be used to hang the laptop bracket 100 vertically from a structure. The second mounting stud 116 may be capable of supporting from 10 Newtons to 30 Newtons of force due mainly to the screen portion 72 of the laptop 70. The first mounting stud 136 may be capable of supporting from 10 Newtons to 50 Newtons of force due mainly to the heavier keyboard portion 74 of the laptop 70.

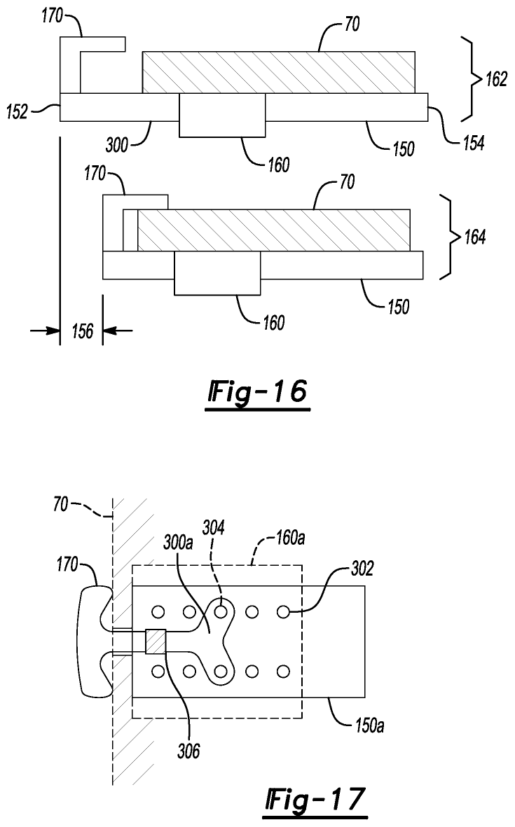

Referring to FIG. 16, a schematic side view diagram of an example of two modes of an arm 150 is shown in accordance with one or more exemplary embodiments. The arm 150 as illustrated is representative of the multiple arms 150 shown in FIG. 1. Each arm has an outer end 152 and an inner end 154. The outer end 152 is connected to a clamp 170. The inner end 154 is connected to either the first support 102 or the second support 122. A moveable segment 300 of the arm 150 allows a length of the arm 150 to be adjusted.

In a first mode 162, the arm 150 may be extended to permit loading and unloading of the laptop 70 in the laptop bracket 100. While the moveable segment 300 is moved away from a center of the laptop bracket 100, the clamp 170 may clear the laptop 70. In a second mode 164, the arm 150 may be retracted to hold the laptop 70 in the laptop bracket 100. The outer end 152 and the moveable segment 300 may be moved an adjustable length 156 toward the center of the laptop bracket 100 such that the clamp 170 engages the holds the laptop 70 to the laptop bracket 100.

Referring to FIG. 17, a schematic plan view diagram of an example implementation of a first arm 150a with a first locking device 160a is shown in accordance with one or more exemplary embodiments. The first arm 150a is representative of the arms 150 illustrated in FIG. 1. The first locking device 160a may represent the locking devices 160 illustrated in FIG. 1.

The first arm 150a includes a first moveable segment 300a and multiple button snaps 302. The first locking device 160a is formed by the button snaps 302 on the first arm 150a and multiple button holes 304 in the first moveable segment 300a. A resilient section 306 is located between the clamp 170 and the first moveable segment 300a. The resilient section 306 helps bias the clamp 170 toward the laptop 70.

To fix a length of the first arm 150a, the first moveable segment 300a is positioned such that the clamp 170 engages the laptop 70. The button snaps 302 are subsequently snapped into the button holes 304 at an appropriate position. To adjust the length of the first arm 150a, the button snaps 302 are removed from the button holes 304, the first moveable segment 300a is moved, and the button snaps 302 are snapped into another corresponding set of button holes 304.

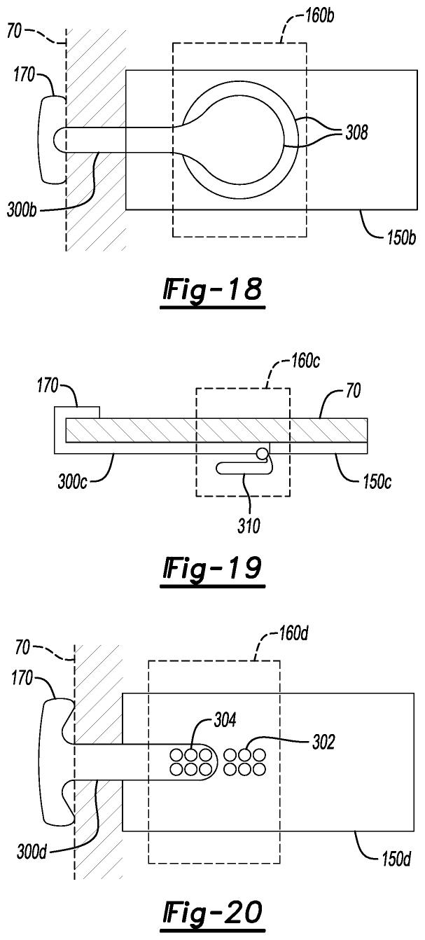

Referring to FIG. 18, a schematic plan view diagram of an example implementation of a second arm 150b with a second locking device 160b is shown in accordance with one or more exemplary embodiments. The second arm 150b is representative of the arms 150 illustrated in FIG. 1. The second locking device 160b may represent the locking devices 160 illustrated in FIG. 1.

The second arm 150b includes a second moveable segment 300b. Velcro fasteners 308 are disposed between the second moveable segment 300b and the second arm 150b. The clamp 170 is attached to the second moveable segment 300b.

To fix the length of the second arm 150b, the Velcro fasteners 308 are squeezed together. To adjust the length of the second arm 150b, the Velcro fasteners 308 are pulled apart and the second moveable segment 300b may be readjusted to an intended position. Thereafter, the Velcro fasteners 308 are squeezed back together.

Referring to FIG. 19, a schematic side view diagram of an example implementation of a third arm 150c with a third locking device 160c is shown in accordance with one or more exemplary embodiments. The third arm 150c is representative of the arms 150 illustrated in FIG. 1. The third locking device 160c may represent the locking devices 160 illustrated in FIG. 1.

The third arm 150c includes a third moveable segment 300c. The third locking device 160c includes a flip clamp 310. While the flip clamp 310 is disengaged, the third moveable segment 300c is free to adjust to an intended length. While the flip clamp 310 is engaged, the third moveable segment 300c is securely coupled to the third arm 150c.

Referring to FIG. 20, a schematic plan view diagram of an example implementation of a fourth arm 150d with a fourth locking device 160d is shown in accordance with one or more exemplary embodiments. The fourth arm 150d is representative of the arms 150 illustrated in FIG. 1. The fourth locking device 160d may represent the locking devices 160 illustrated in FIG. 1.

The fourth arm 150d includes a fourth moveable segment 300d and multiple button snaps 302. The fourth locking device 160d is formed by the button snaps 302 on the fourth arm 150d and multiple button holes 304 in the fourth moveable segment 300d. The clamp 170 is attached directly to the fourth moveable segment 300d.

To fix a length of the fourth arm 150d, the fourth moveable segment 300d is positioned such that the clamp 170 engages the laptop 70. The button snaps 302 are subsequently snapped into the button holes 304 at an appropriate position. To adjust the length of the fourth arm 150d, the button snaps 302 are removed from the button holes 304, the fourth moveable segment 300d is moved, and the button snaps 302 are snapped into another corresponding set of button holes 304.

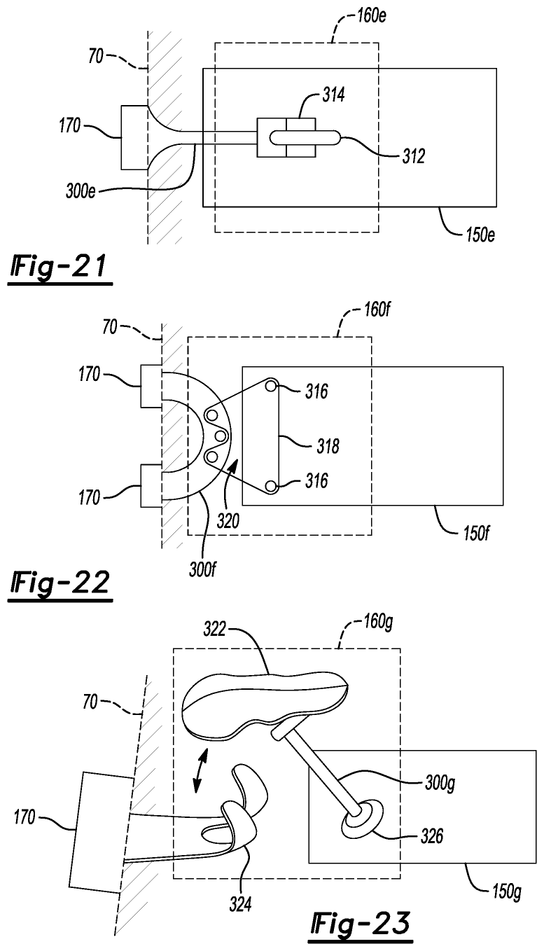

Referring to FIG. 21, a schematic plan view diagram of an example implementation of a fifth arm 150e with a fifth locking device 160e is shown in accordance with one or more exemplary embodiments. The fifth arm 150e is representative of the arms 150 illustrated in FIG. 1. The fifth locking device 160e may represent the locking devices 160 illustrated in FIG. 1.

The fifth arm 150e includes a fifth moveable segment 300e and an arm buckle 314. The fifth moveable segment 300e includes a belt 312. The fifth locking device 160e is formed by the belt 312 and the arm buckle 314. The clamp 170 is attached directly to the fifth moveable segment 300e.

To fix a length of the fifth arm 150e, the belt 312 is attached to the arm buckle 314. To adjust the length of the fifth arm 150e, the belt 312 is removed from the arm buckle 314.

Referring to FIG. 22 a schematic plan view diagram of an example implementation of a sixth arm 150f and a sixth locking device 160f is shown in accordance with one or more exemplary embodiments. The sixth arm 150f is representative of the arms 150 illustrated in FIG. 1. The sixth locking device 160f may represent the locking devices 160 illustrated in FIG. 1.

The sixth arm 150f includes a sixth moveable segment 300f. The sixth locking device 160f includes multiple pegs 316 and a stretch band 318. Some of the pegs 316 are disposed on the sixth moveable segment 300f. Other pegs 316 are disposed on the sixth arm 150f. One or more clamps 170 are connected to the sixth moveable segment 300f. The stretch band 318 engages the pegs 316 to bias the clamps 170 toward the laptop 70. A gap 320 may exist between the sixth moveable segment 300f and the sixth arm 150f while engaging the laptop 70.

Referring to FIG. 23, a schematic perspective view diagram of an example implementation of a seventh arm 150g and a seventh locking device 160g are shown in accordance with one or more exemplary embodiments. The seventh arm 150g is representative of the arms 150 illustrated in FIG. 1. The seventh locking device 160g may represent the locking devices 160 illustrated in FIG. 1.

The seventh arm 150g includes a pivotable fastener 326. The seventh locking device 160g includes a seventh moveable segment 300g, a latch 322, and a hook latch 324. The seventh moveable segment 300g may be made of a stretchy material, such as a ½ inch diameter to a ¾ inch diameter rubber rod. The seventh moveable segment 300g is connected to the pivotable fastener 326 at one end and the latch 322 at the other.

To fix a length of the seventh arm 150g, the latch 322 engages the hook latch 324 and the latch 322 is closed. To adjust the length of the seventh arm 150g, the latch 322 disengages the hook latch 324 allowing the seventh moveable segment 300g to be adjusted in length.

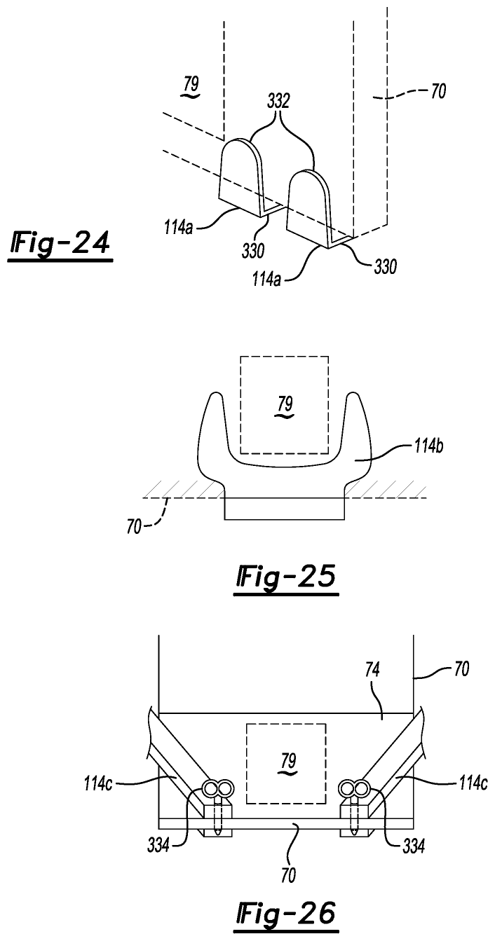

Referring to FIG. 24, a schematic perspective view diagram of an example implementation of a first mechanical stop 114a is shown in accordance with one or more exemplary embodiments. The first mechanical stop 114a includes stop hinges 330 and pads 332. The first mechanical stops 114a are disposed along the first side 106 of the first support 102 in locations that reside away from a mousepad 79 of the laptop 70.

Referring to FIG. 25, a schematic plan view diagram of an example implementation of a second mechanical stop 114b is shown in accordance with one or more exemplary embodiments. The second mechanical stop 114b includes stop hinges 330 and pads 332. The second mechanical stop 114b is disposed along the first side 106 of the first support 102 centered on the mousepad 79 of the laptop 70. The mechanical stop 114b may include a wishbone shape that avoids overlapping the mousepad 79.

Referring to FIG. 26, a schematic perspective view diagram of an example implementation of a third mechanical stop 114c is shown in accordance with one or more exemplary embodiments. The third mechanical stop 114c includes thumb screws 334. The third mechanical stops 114c are disposed along the second side 108 and the third side 110 of the first support 102 and cross over the corners of the keyboard portion 74 of the laptop 70. The thumb screws 334 hold the third mechanical stops 114c against the keyboard portion 74 of the laptop 70, outside the area covered by the mousepad 79. In various embodiments, the third mechanical stops 114c help clamp the laptop 70 to the laptop bracket 100.

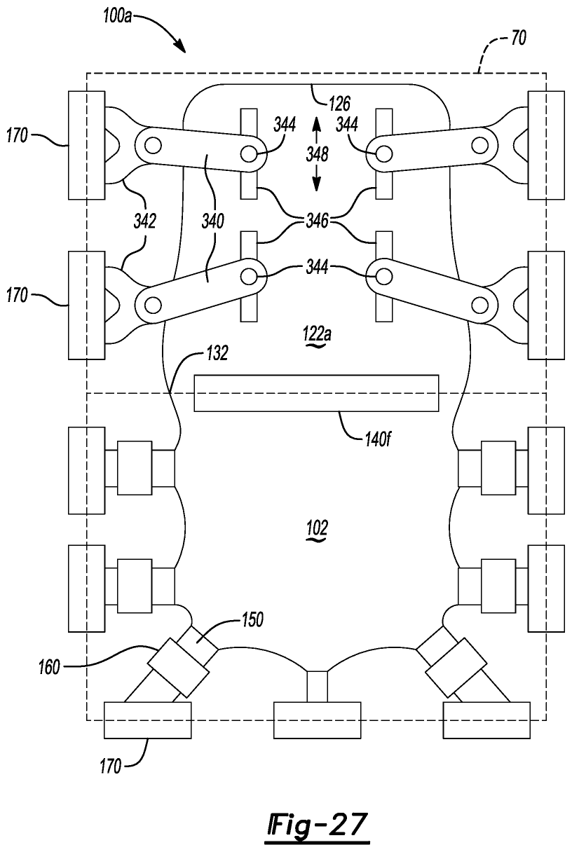

Referring to FIG. 27, a schematic bottom view diagram of an example implementation of a second laptop bracket 100a is shown in accordance with one or more exemplary embodiments. The second laptop bracket 100a may be a variation of the laptop bracket 100. The second laptop bracket 100a includes the first support 102 and a dynamic second support 122a. A fourth hinge device 140f (e.g., a simple hinge) may connect the first support 102 to the dynamic second support 122a.

The first support 102 may include the arms 150, locking device 160, and clamps 170, as before. The dynamic second support 122a includes multiple tracks 346 oriented from the sixth side 128 to the eighth side 132.

The arms implement sliding arms 340. A track follower 344 is connected to the sliding arms 340 and are disposed in the tracks 346. Couplers 342, more locking devices 160, and more clamps 170 are connected to the sliding arms 340 opposite the track followers 344. The track followers 344 allow the sliding arms 340 to move in a sliding motion 348 in response to the laptop 70 being opened and closed. Therefore, the dynamic second support 122a moves in the sliding motion 348 relative to the screen portion 72 of the laptop 70 as the laptop 70 is opened and closed.

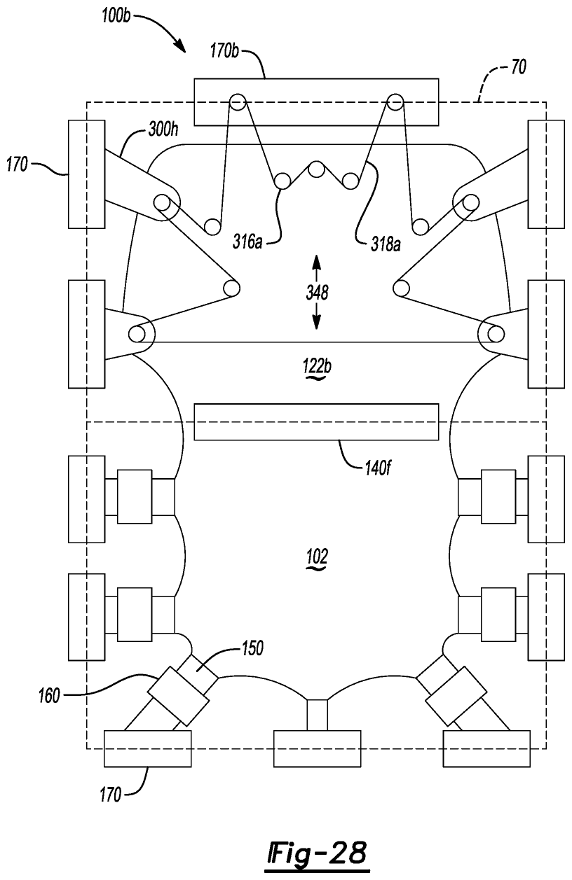

Referring to FIG. 28, a schematic bottom view diagram of an example implementation of a third laptop bracket 100b is shown in accordance with one or more exemplary embodiments. The third laptop bracket 100b may be a variation of the laptop bracket 100 and/or the second laptop bracket 100a. The third laptop bracket 100b includes the first support 102 and a static second support 122b. The fourth hinge device 140f (e.g., a simple hinge) may connect the first support 102 to the static second support 122b.

The first support 102 may include the arms 150, locking device 160, and clamps 170, as before. The static second support 122b includes multiple eighth moveable segments 300h. Multiple second pegs 316a are connected to the static second support 122b and the eighth moveable segments 300h. A second stretch band 318a wraps around the second pegs 316a to bias the claims 170 inward toward the laptop 70.

In response to the laptop 70 opening and closing, the fourth hinge device 140f maintains a constant separation between the first support 102 and the static second support 122b. Therefore, the second stretch band 318a allows the eighth moveable segments 300h to moves in the sliding motion 348 relative to the screen portion 72 of the laptop 70 as the laptop 70 is opened and closed.

Numerical values of parameters (e.g., of quantities or conditions) in this specification, including the appended claims, are to be understood as being modified in instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of values and further divided ranges within the entire range. Each value within a range and the endpoints of a range are hereby disclosed as a separate embodiment.

While the best modes for carrying out the disclosure have been described in detail, those familiar with the art to which this disclosure relates will recognize various alternative designs and embodiments for practicing the disclosure within the scope of the appended claims.

What is claimed is:

1. A laptop bracket configured to hold a laptop having an outer perimeter and a screen portion coupled to a keyboard portion through a laptop hinge, the laptop bracket comprising:
a first support that defines a first planar surface, a first side, a second side, a third side opposite the second side, and a fourth side opposite the first side, wherein the first support is configured to receive the keyboard portion of the laptop against the first planar surface;
a second support that defines a second planar surface, a fifth side, a sixth side, a seventh side opposite the sixth side, and an eighth side opposite the fifth side, wherein the second support is configured to receive the screen portion of the laptop against the second planar surface;
a plurality of hinge devices coupled between the fourth side of the first support and the eighth side of the second support, wherein the plurality of hinge devices are configured to rotatably couple the first support to the second support, and accommodate a variable separation between the fourth side of the first support and the eighth side of the second support in response to a rotation of the laptop hinge;
a plurality of arms each having an outer end moveable proximate the outer perimeter of the laptop, wherein:
each of the plurality of arms has an inner end opposite the outer end and separated from the outer end by an adjustable length; and
the inner ends are attached to the first side, the second side, and the third side of the first support, and the fifth side, the sixth side, and the seventh side of the second support; and
a plurality of clamps attached to the outer ends of the plurality of arms, wherein the plurality of clamps are configured to grip the keyboard portion and the screen portion of the laptop proximate the outer perimeter of the laptop.

2. The laptop bracket according to claim 1, wherein the adjustable length of each of the plurality of arms is held constant while the second support is rotated relative to the first support.

3. The laptop bracket according to claim 2, further comprising:
a plurality of locking devices connected to plurality of arms, wherein each of the plurality of locking devices is configured to hold constant the adjustable length of one of the plurality of arms in a first mode, and enable the adjustable length to change in a second mode.

4. The laptop bracket according to claim 2, wherein a plurality of locations of the plurality of clamps on the laptop is held stationary while the second support is moved relative to the first support.

5. The laptop bracket according to claim 1, wherein the plurality of arms and the plurality of clamps along the first side of the first support are configured to hold the laptop stationary while the keyboard portion of the laptop applies a force of up to 70 newtons of force in a direction parallel to the first planar surface and from the fourth side toward the first side.

6. The laptop bracket according to claim 1, further comprising:
a mechanical stop attached to the first support proximate the first side and protruding normal to the first planar surface, wherein the mechanical stop is configured to prevent the keyboard portion of the laptop from moving a direction from the fourth side toward the first side.

7. The laptop bracket according to claim 1, wherein the plurality of hinge devices comprises a plurality of double-action hinges.

8. The laptop bracket according to claim 1, further comprising:
at least one mounting stud connected to the first support.

9. The laptop bracket according to claim 1, further comprising:
at least one mounting stud connected to the second support.

10. The laptop bracket according to claim 1, wherein at least one of the plurality of clamps comprises:
a flexible bar having an open end and a connector end opposite the open end, wherein the connector end is coupled to the outer end of one of the plurality of arms; and
a resilient pad disposed at the open end, wherein the resilient pad is configured to bias the laptop against the one of the plurality of arms.

11. The laptop bracket according to claim 1, wherein at least one of the plurality of clamps comprises:
a resilient pad configured to engage the laptop;
a bar coupled between the resilient pad and the outer end of one of the plurality of arms; and
a joint disposed between the bar and the outer end of the one of the plurality of arms, wherein the joint is spring-loaded to force the resilient pad against the laptop to force the laptop against the one of the plurality of arms.

12. The laptop bracket according to claim 1, wherein at least one of the plurality of clamps comprises:
a plate configured to engage the laptop; and
a thumb screw disposed between the plate and the outer end of one of the plurality of arms, wherein the thumb screw forces the plate against the laptop to force the laptop against the one of the plurality of arms.

13. The laptop bracket according to claim 1, wherein at least one of the plurality of clamps comprises:
a spring-loaded joint coupled to the outer end of one of the plurality of arms; and
a plurality of squeeze pads coupled to the spring-loaded joint, wherein the plurality of squeeze pads is configured to bias the laptop against the one of the plurality of arms.

14. The laptop bracket according to claim 1, wherein at least one of the plurality of clamps comprises:
a clip rotatably coupled to the outer end of one of the plurality of arms, wherein the clip is configured to engage the laptop; and
a plurality of magnets disposed between the clip and the outer end of the one of the plurality of arms, wherein the plurality of magnets force the clip against the laptop to force the laptop against the plurality of arms.

15. The laptop bracket according to claim 1, wherein at least one of the plurality of clamps comprises:
an adjustable strap connected to one of the outer ends of the plurality of arms, wherein the adjustable strap is configured to bias the laptop against the one of the plurality of arms.

16. The laptop bracket according to claim 1, wherein at least one of the plurality of hinge devices comprises:
a double-action hinge connected between the first support and the second support.

17. The laptop bracket according to claim 1, wherein at least one of the plurality of hinge devices comprises:
a strap connected between the first support and the second support, wherein the strap includes a plurality of serrated teeth that enables the strap to adjust in length as the laptop is opened and closed.

18. The laptop bracket according to claim 1, wherein at least one of the plurality of hinge devices comprises:
a lower bridge coupled to the first support; and
an upper bridge coupled to the second support, wherein a plurality of pop studs and a plurality of holes releasably couple the lower bridge to the upper bridge at a plurality of locations.

19. The laptop bracket according to claim 1, further comprising:
a first mounting stud coupled to the first support; and
a second mounting stud coupled to the second support,
wherein the first mounting stud is configured to hold the first planar surface of the first support at an angle of approximately 30 degrees to approximately 60 degrees relative to the second planar surface of the second support.

20. A method for supporting a laptop having an outer perimeter and a screen portion coupled to a keyboard portion through a laptop hinge, the method comprising:
receiving the keyboard portion of the laptop against a first planar surface of a first support, wherein the first support defines the first planar surface, a first side, a second side, a third side opposite the second side, and a fourth side opposite the first side;
receiving the screen portion of the laptop against a second planar surface of a second support, wherein the second support defines the second planar surface, a fifth side, a sixth side, a seventh side opposite the sixth side, and an eighth side opposite the fifth side;
rotatably coupling the first support to the second support with a plurality of hinge devices coupled between the fourth side of the first support and the eighth side of the second support, wherein the plurality of hinge devices are configured to accommodate a variable separation between the fourth side of the first support and the eighth side of the second support in response to a rotation of the laptop hinge;
moving an outer end of each of a plurality of arms proximate to the outer perimeter of the laptop, wherein:
each of the plurality of arms has an inner end opposite the outer end and separated from the outer end by an adjustable length; and
the inner ends are attached to the first side, the second side, and the third side of the first support, and the fifth side, the sixth side, and the seventh side of the second support; and
gripping the keyboard portion and the screen portion of the laptop proximate to the outer perimeter of the laptop with a plurality of clamps, wherein the plurality of clamps are attached to the outer ends of the plurality of arms.
